(19) United States
(12) Patent Application Publication
(10) Pub. No.: US 2011/0004520 A1
(43) Pub. Date: Jan. 6, 2011

(54) SYSTEM TO PRESENT BUSINESS NETWORK NOTIFICATIONS IN CONJUNCTION WITH DISPLAY ADVERTISEMENTS

(75) Inventors: Jack Weichieh Chou, Los Altos, CA (US); Ganesh Shekharipuram Hariharan, San Ramon, CA (US); Sanjay Sureshchandra Dubey, Fremont, CA (US); David Hahn, Palo Alto, CA (US)

Correspondence Address: SCHWEGMAN, LUNDBERG & WOESSNER, P.A., P.O. BOX 2938, MINNEAPOLIS, MN, 55402, US

(73) Assignee: Linkedln Corporation, Mountain View, CA (US)

(21) Appl. No.: 12/641,181

(22) Filed: Dec. 17, 2009

Related U.S. Application Data
(60) Provisional application No. 61/223,357, filed on Jul. 6, 2009.

(51) Int. Cl. G06Q 30/00; G06Q 99/00

(52) U.S. Cl. 705/14.53

(57) ABSTRACT

Some embodiments of the present invention provide a mechanism for displaying in conjunction with a display advertisement one or more social network notifications or business network notifications generated from an online or web-based social/business networking service. The social/business network notifications displayed to a particular user generally include content that is associated with persons to whom the particular user is connected via a person-to-person connection established via the social/business networking service, and content that has some nexus to the display advertisement. In some instances, the network notification may relate to an interaction that a user has had with one or more services provided by the business or social networking service.

### TECHNICAL FIELD

The present disclosure generally relates to the presentation of online display advertisements. More specifically, the present disclosure relates to methods and systems for presenting social network and/or business network notifications in conjunction with display advertisements.

### BACKGROUND

A social networking service is a computer- or web-based application that enables users to establish links or connections with persons for the purpose of sharing information with one another. Some social networks aim to enable friends and family to communicate with one another, while others are specifically directed to business users with a goal of enabling the sharing of business information. With many social or business network services, users are frequently requesting and viewing web pages that contain very little “content” in the traditional sense. For example, users of business networking services typically request and view other users' profile pages, which typically contain biographical information (e.g., contact information, educational background, past and present employment status, and so forth) about the respective users. Similarly, a user's home page or landing page may contain a variety of information about his or her friends, or business contacts. Consequently, the web pages of many social and/or business networking services often lack the contextual relevance that has proven very successful for advertising campaigns with certain intent-based Internet advertising sites, such as search engines that display search results pages.

### DESCRIPTION OF THE DRAWINGS

Some embodiments are illustrated by way of example and not limitation in the figures of the accompanying drawings, in which:

FIG. 1 is a block diagram showing various functional modules comprising an online or web-based social or business networking service, with which an embodiment of the invention might be implemented;

FIG. 2 illustrates an example of a method by which an advertiser establishes an advertising campaign to have display ads embedded in the content (e.g., web pages) of a social and/or business networking service, according to an embodiment of the invention;

FIG. 3 illustrates an example of a method for detecting and storing the interactions a user has with a social/business networking service, for the purpose of processing, analyzing and storing data for use in identifying relevant contextual information to be presented with a display advertisement, according to an embodiment of the invention;

FIG. 4 illustrates an example of a method for serving social network or business network notifications in conjunction with a display ad, according to an embodiment of the invention;

FIG. 5 illustrates an example of a method for serving social network and/or business network notifications in conjunction with a display ad, according to an embodiment of the invention;

FIGS. 6 and 7 illustrate examples of various user interfaces showing display advertisements presented in conjunction with social/business network notifications, according to an embodiment of the invention; and

FIG. 8 is a block diagram of a machine in the form of a computer within which a set of instructions, for causing the machine to perform any one or more of the methodologies discussed herein, may be executed.

### DETAILED DESCRIPTION

Methods and systems for displaying social/business network notifications in conjunction with display advertisements are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Many of the examples described herein are provided in the context of a business networking service (e.g., an online social networking service specifically aimed at business users), such as that operated by LinkedIn, Inc. of Mountain View, Calif. However, the inventive concepts are equally applicable to a variety of online or computer-based social networking services. Consistent with embodiments of the present invention, a business networking or social networking service is an online or web-based application that enables a person to identify and establish links or connections with other persons (e.g., person-to-person connections). For instance, in the context of a business networking service, a person may establish a link or connection with his or her business contacts, including work colleagues, clients, customers, and so on. With a social networking service, a person may establish links or connections with his or her friends and family. In general, a connection or link represents or is otherwise associated with an information access privilege, such that a first person who has established a connection with a second person is, via the establishment of that connection, authorizing the second person to view or access certain personal information, such as contact information (e.g., phone numbers, an address, employment information, photographs, status information, and so on). Those users of the business/social networking service who are not connected to the first user are not permitted or authorized to access or view the first user's personal information. Of course, depending on the particular implementation of the business/social networking service, the nature and type of the information that may be shared, as well as the granularity with which the access privileges may be defined to protect certain types of data can vary greatly.

In some embodiments of the present invention, when a display advertisement (ad) is presented to a user in a web page of a business networking service (or an affiliated publisher), additional content is displayed next to, or, near the ad. This additional content is referred to herein as a network notification. Specifically, in the context of a business networking service, this additional content is referred to as a business network notification, and in the context of a social networking service, the additional content is referred to herein as a social network notification. In some instances, the social/business network notifications include content that is selected based on its relevance to the content of the ad and one or more persons with whom the user has established a person-to-person connection via the social or business networking service. In some instances, the social/business network notifications include content that is selected based on its relevance to a particular topic associated with the content of the ad.

For example, a business network notification may be displayed next to or near an ad to inform a user of an existing relationship between one or more persons with whom the user has established a person-to-person connection via the business/social networking service, and an entity, association, group or person that is identified in or closely associated with the ad. For instance, if the ad is for a graduate degree program at a particular university, a business network notification may identify one or more persons with whom the user (e.g., the person viewing the web page) is connected who have earned degrees from the university's graduate degree program. Similarly, the business network notification may indicate the names and/or number of persons, with whom the user is connected via the business networking service, who are alumni of the particular educational institution associated with the ad. For instance, in such a scenario, a business network notification may appear as, “17 of your connections went to school at Wharton.” Similarly, if an ad is for an educational institution, the business network notifications may identify groups that are associated with the educational institution, such as alumni groups.

Alternatively, if the ad is related to a technology company, the business network notification may identify persons in the user's network who have experience with a technology associated with the technology company. For instance, if the ad is for a particular product or service (e.g., technology product), or if the ad is related to a particular topic (e.g., legal, business, and so on) the business network notifications may indicate to the user those persons in the user's person-to-person network who have asked, or answered, questions about the product, service or topic. For instance, in such a scenario, a business network notification may appear as, “Brian Lee, who is in your 2nd degree network, asked this question.” In some instances, the business network notification may indicate that the business network service has one or more groups that are associated with a particular product, service or topic.

In some embodiments, the information that is used to link persons in a user's network to the content of an ad will come from information extracted from the person's personal information displayed on the person's profile page. For instance, if a person indicates that he or she graduated from a particular university with a particular degree, this information can be used to associate the person with an ad for the particular university or degree program. Similarly, if a person indicates that he or she has a certain technical skill (e.g., Java Programmer), this information might also be used to link the person to an ad.

In some embodiments, the information that is used to link a person to an ad will come from information associated with one or more of a variety of applications, programs or services offered by the business/social networking service. For instance, some business networking services offer a variety of programs or services, such as user groups, or “Groups”, and topic forums, which may also be known as “Ask the Expert” or “Questions and Answers” services. Although some specific examples are provided, those skilled in the art of business/social networking services will readily appreciate the vast number and types of applications, programs and services, beyond those that are explicitly described herein, that might be utilized in establishing relationships between users of the business/social networking services and content of display ads.

A “Groups” service, for example, may enable persons to self organize into groups based on a common interest or association, for the purpose of sharing information on a particular topic. An example might be an alumni group for a particular college or university. Another example might be a group for a particular profession or a particular specialty within a profession, such as a group for dentists, doctors, lawyers, or dentists specializing in cosmetic dentistry and attorneys specializing in tax law, and so forth. These groups may be assigned to categories that can be used to associate persons belonging to a group with the content of an ad.

A topic forum, or “Ask the Expert” or “Questions and Answers” service, provides a forum for users to submit questions to other persons within the user's network, who may have a particular technical or professional specialty. The forum may be divided into categories (e.g., business, legal, technology) allowing users to more narrowly direct their questions to the appropriate audience, and to search for previously asked questions and associated answers on certain topics. A person's participation in the forum may be utilized to link the person to a particular ad. For example, if a person has asked or answered several questions regarding a particular technology, a link between the person and an ad may be established where the particular technology falls within the same category, or has a similar topic, as the content of the ad. In such a scenario, a business network notification may be displayed next to an ad to indicate that a person to whom the user (e.g., the viewer of the page containing the ad) is connected via the networking service has asked or answered one or more questions associated with a topic or category of the ad being displayed. Other aspects of the inventive subject matter will become readily apparent from the description of the figures that follows.

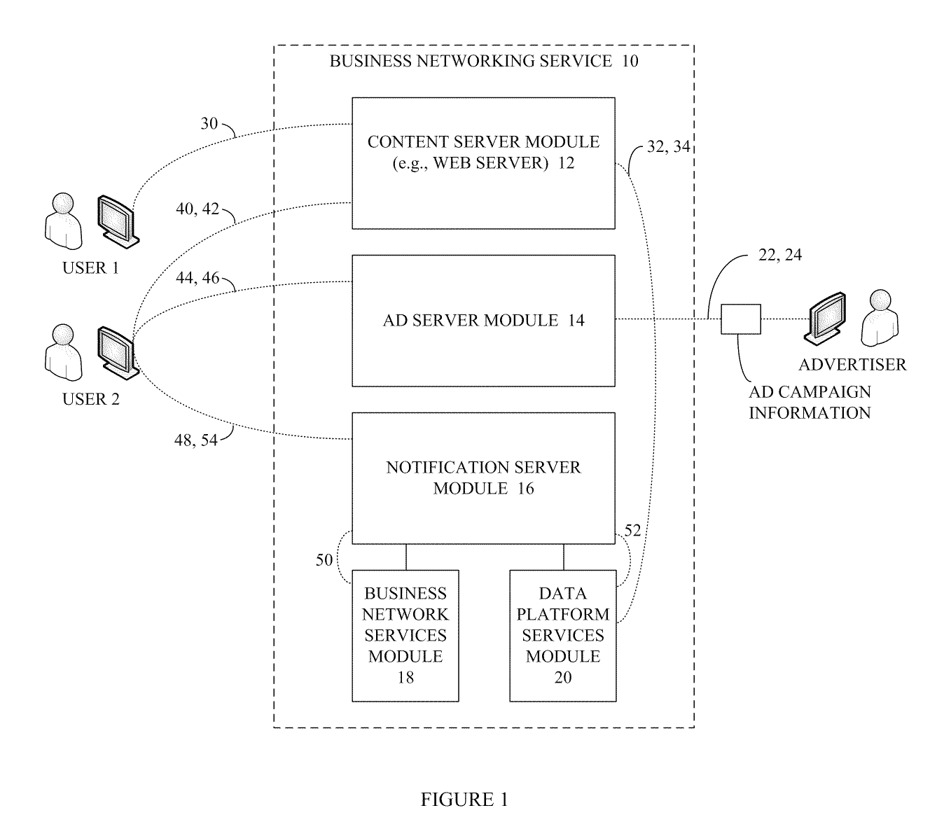

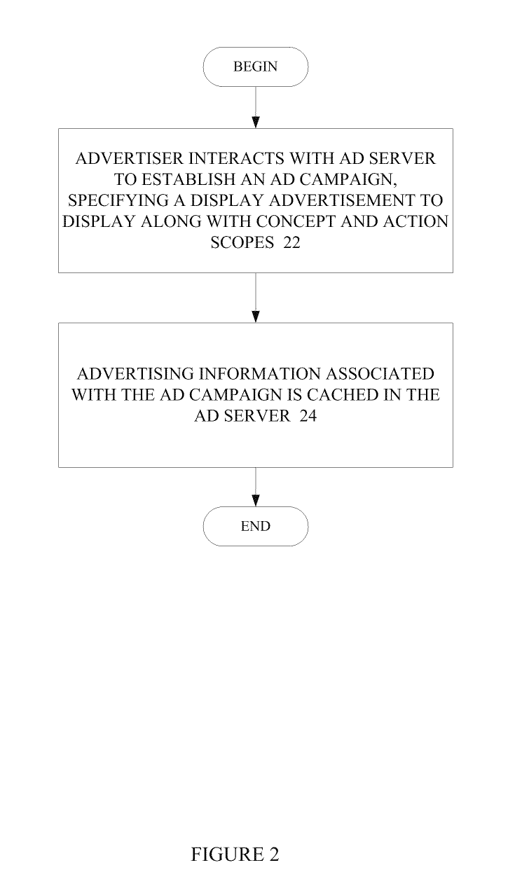

FIG. 1 is a block diagram showing various functional modules comprising an online or web-based business networking service, with which an embodiment of the invention might be implemented. As illustrated in FIG. 1, the business networking service 10 includes a content server module (e.g., a web server) 12, an ad server module 14, and a notification server module 16. In addition, the notification server 16 is shown to be associated with business network services module 18 and data platform services module 20. The various functions of each module or server component illustrated in FIG. 1 are described below in connection with the description of the methods illustrated in FIGS. 2 through 5.

Consistent with an embodiment of the invention, ads embedded in the web pages of the business networking service are provided by advertisers. In addition to supplying ads, advertisers specifically configure various parameters of an ad campaign, including what are referred to herein as concept and action scopes, to present business network notifications in conjunction with the ads. Accordingly, FIG. 2 illustrates an example of a method by which an advertiser establishes an ad campaign to have display ads embedded in the content (e.g., web pages) of a business networking service, according to an embodiment of the invention. In FIG. 2, at method operation 22, an advertiser interacts with an ad server 14 to establish an ad campaign. The interaction with the ad server 14 may be facilitated by a graphical user interface provided by one or more web pages rendered in a browser application. In defining the ad campaign, in addition to providing conventional ad campaign specifications (e.g., categories and/or keywords for triggering the presentation of an ad), the advertiser specifies concept and action scopes—campaign configuration parameters that are used to identify and select relevant business network notifications for display next to, or near, an ad. For example, the concept and action scopes define how the notification server 16 is to select, serve and display business network notifications in conjunction with the advertiser's ad.

In some embodiments, the establishment of an ad campaign by an advertiser is facilitated by an advertiser-facing user interface. For instance, a campaign configuration module (not shown) may have an associated interface that enables an advertiser to input or provide the various parameters (e.g., display ads, and concept and action scopes) for “matching” ads to web pages, and business network notifications to ads and users of the networking service. In alternative embodiments, an account manager or another administrator of the social or business networking service may perform the ad campaign setup on behalf of an advertiser. For instance, in some embodiments, the campaign configuration module and associated user interface may be accessible only to authorized administrators or account managers of the business network service. As such, the administrators or account managers may gather all of the relevant information from the advertiser (e.g., via telephone and/or email exchanges, and so forth), and then utilize the gathered information to configure the ad campaign on behalf of the advertiser.

In some embodiments, the concept and action scopes determine the type of business network notifications that are to be displayed next to or near certain ads. The type of business network notification may indicate the particular source from which the business network notifications are selected. For example, in some embodiments, an advertiser may opt to have business network notifications selected from various sources including, for example, information from users' profile or resume pages, and/or information concerning various interactions that users have had with different applications or services provided by the business/social networking service. In general, the notifications may be selected based on the existence of a personal connection between the user (e.g., the viewer of the ad) and one or more persons to whom the viewer is connected via the business networking service. By way of example, if the ad is for an educational institution, such as a university, a network notification may be selected to inform the user of one or more connections (e.g., other users of the networking service to whom the view of the ad is linked) who have attended the educational institution. For this particular example, the business network notification type may indicate that notifications are to be selected from users' profile pages. Accordingly, when the advertiser is initially setting up the ad campaign, the advertiser may be able to define the concept and action scopes to select business network notifications that identify persons in a user's network who have attended the particular university being advertised. In some instances, the advertiser may be able to specify a level of connection required in order to trigger the display of a business network notification. For example, the level of connection between any two users of a business or social network will be dependent upon the particular implementation of the networking service. In some cases, for example, a level of connection may be defined as a first degree connection, for example, indicating that the two users have a direct relationship. Similarly, a second degree connection may indicate that a user is once removed from another user. In other embodiments, levels of connection may be established by specifying direct friends only, or friends of friends, and so on.

In some embodiments, the concept and action scopes may indicate that notifications are to be based on the existence of topical content at the business networking service that is associated with some aspect of the ad. For example, in some embodiments, topical content may include content from one or more topical forums such as an “Ask the Expert” or “Questions and Answers” service facilitated by the business networking service 10, which allows users of the service to ask questions, and provide answers on various topics. In some embodiments, the concept and action scopes may provide the advertiser with relatively granular controls over the notifications that are to be presented in conjunction with an ad. Generally, the concept and action scopes will vary depending on the type and nature of the content available from the social/business networking service and utilized in the notifications, as well as the nature of the interactions that occur between the users of the social/business networking service and the content. In some embodiments, each ad can be associated with one or more topics or categories, as well as sub-topics or sub-categories. These topics and/or categories can then be matched with categorized content from one or more applications of the networking service. For instance, an “Ask the Expert” or “Question and Answer” application may have question-answer pairs that are categorized, for instance, based on the content or topic of the question, and/or answer. Accordingly, network notifications can be selected from content that is associated with a particular category or topic. In any case, at method operation 24, the information defining the ad campaign, including the advertiser-specified concepts and action scopes are stored at the ad server 14, where they can be used by the ad server in the selection of network notifications for display next to or near certain ads.

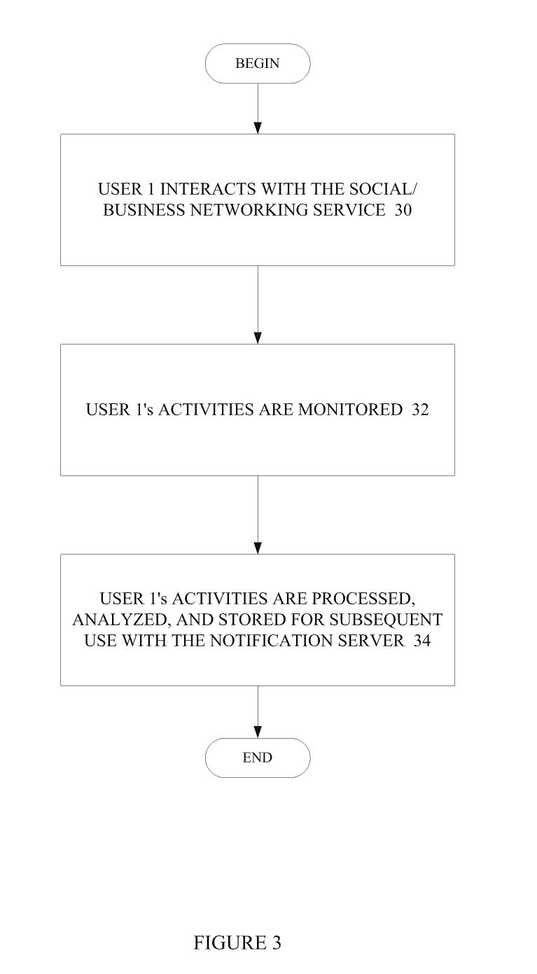

Before business network notifications can be served in conjunction with ads, the interactions of the users of the business networking service with the content are processed, analyzed and stored for use with the notification server 16. Accordingly, FIG. 3 illustrates an example of a method for detecting and storing the interactions a user has with a social/business networking service, for the purpose of processing, analyzing and storing data for use in identifying relevant contextual information to be presented with a display advertisement, according to an embodiment of the invention. As illustrated in FIG. 3, at method operation 30 a user (e.g., User 1) interacts with the business networking service. In general, the interaction is facilitated by a web browser application and a content server 12, which may be a web server. Accordingly, web pages are served to User 1 by the content server 12, and rendered in the browser application of User 1. The web pages may include user profile pages, providing various biographical information of other users of the business networking service. Additionally, the web pages may include pages associated with one or more groups to which User 1 has joined. For instance, in some embodiments, the business networking service facilitates the establishment of groups that users can join at will, or in some cases, by invitation. Among other things, the groups facilitate the communication of relevant information between members of the groups. In some instances, the web pages may include pages associated with an “Ask the Expert” or “Questions and Answers” service facilitated by the business networking service 10. In any case, as User 1 requests various web pages and interacts with the business networking service, at method operation 32 the interactions (e.g., content requests) are monitored. Accordingly, at method operation 34, the data captured from detecting User l's interactions with the business networking service are processed, analyzed and stored for later use by the notification server 16.

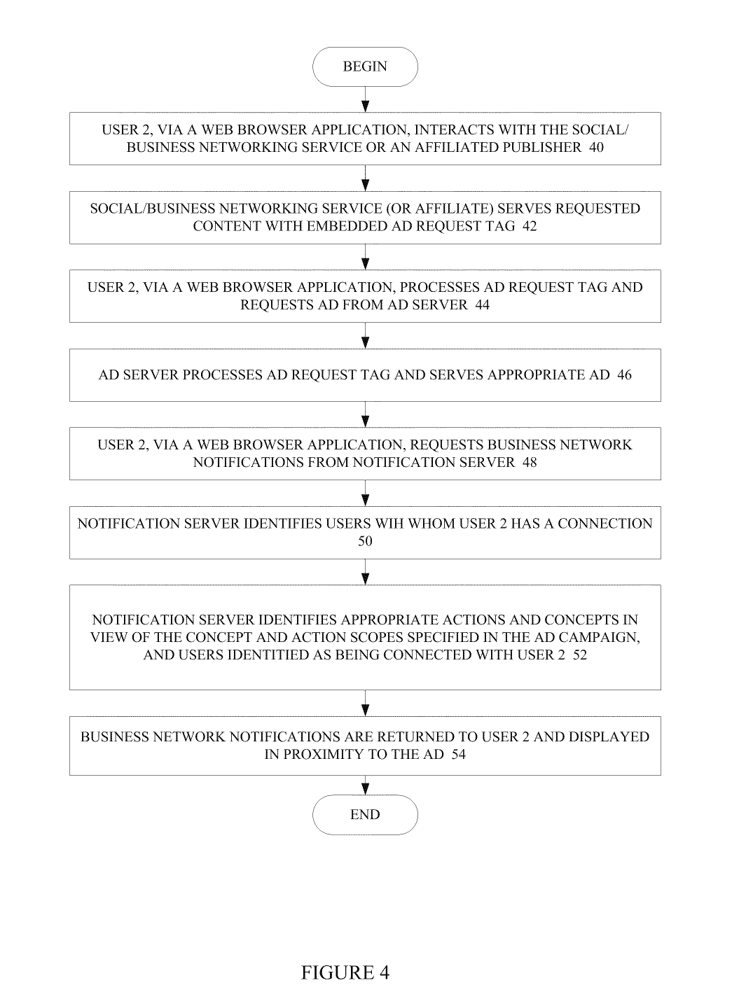

FIG. 4 illustrates an example of a method for serving social/business network notifications in conjunction with a display advertisement, according to an embodiment of the invention. At method operation 40, a user (e.g., User 2) utilizes a web browser application to interact with the business networking service 10, for example, by specifying an address of the networking service and thereby causing the web browser to request content (e.g., a web page) from the business networking service's content server 12. In response to the request, at method operation 42 the content server 12 communicates a web page to the browser application of User 2. The web page includes an ad request tag that serves as a place holder in the web page for an ad to be served by the ad server 14. When the browser application of User 2 processes the ad request tag, at method operation 44 an ad request is communicated from User 2's browser application to the ad server 14. In response, the ad server 14 serves a suitable ad to the web browser application of User 2, and in turn, the ad is rendered and displayed in the web page.

At method operation 46, when the browser application receives the ad from the ad server 14, a request is triggered for business network notifications associated with the ad. For example, the browser application of User 2 automatically communicates a request to the notification server 16 of the business networking service 10, requesting business network notifications. The request may include information that identifies User 2 as well as information that identifies the ad that has been served to the web browser of User 2. At method operation 50, the notification server 16 processes the request by first identifying the users that are related to (e.g., connected with) User 2 via the business networking service. In some embodiments, identifying the users associated with User 2 is achieved by polling or otherwise requesting the information from the business network services module 18. For instance, as users establish connections with one another, the information identifying the various connections may be stored at or by the business network services module 18.

Next, at method operation 52 the notification server 16 queries the data platform services 20 for business notifications that satisfy the concept and action scopes associated with the ad that has been served. The data platform services module 20 stores the data resulting from the method operation 34. Finally, at method operation 54 the business network notifications determined to satisfy the concept and action scopes are returned or communicated to the browser application of User 2, where the business network notifications are presented or displayed in the requested web page in conjunction with the presentation of the ad.

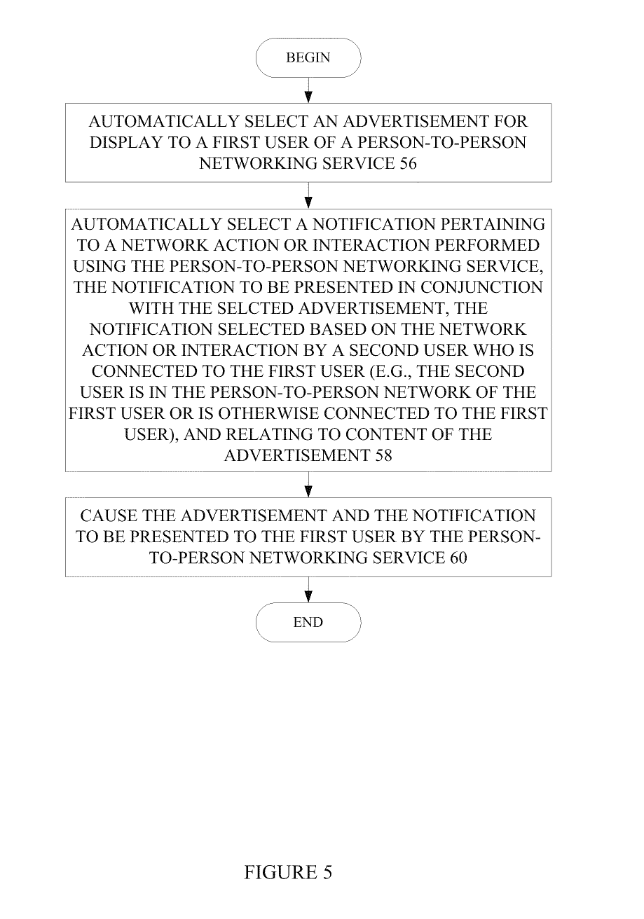

FIG. 5 illustrates an example of a method for serving social/business notifications in conjunction with a display advertisement, according to an embodiment of the invention. At method operation 56, an advertisement is automatically selected for display to a first user of a person-to-person networking service. At method operation 58, a network notification is automatically selected. For example, in some embodiments, the network notification is selected based at least in part on identifying a connection between the user (e.g., viewer of the ad) and one or more persons to whom the user is connected via the networking service. Once the relevant connections have been identified, the concept and action scopes are analyzed to determine whether one or more of the relevant connections has information in their profile, or has prior interactions with one or more applications of the networking server, that satisfy the advertiser-specified concept and action scopes. For example, the network notification may be selected based on a network interaction being associated with a second user who is related to the first user via a chain of person-to-person connections connecting the first user with the second user, where the network interaction relates to content of the advertisement, thereby satisfying a concept scope specified by the advertiser. Finally, at method operation 60, the networking service causes the ad and the notification to be presented to the first user.

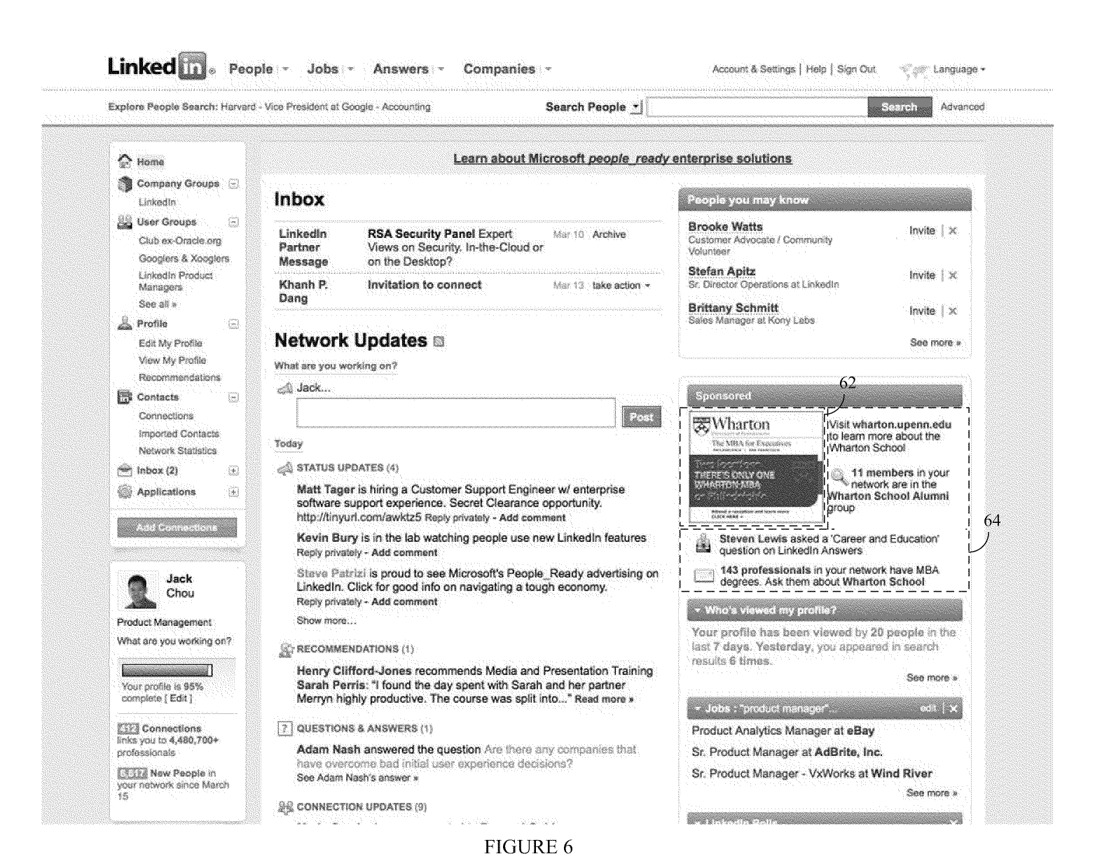

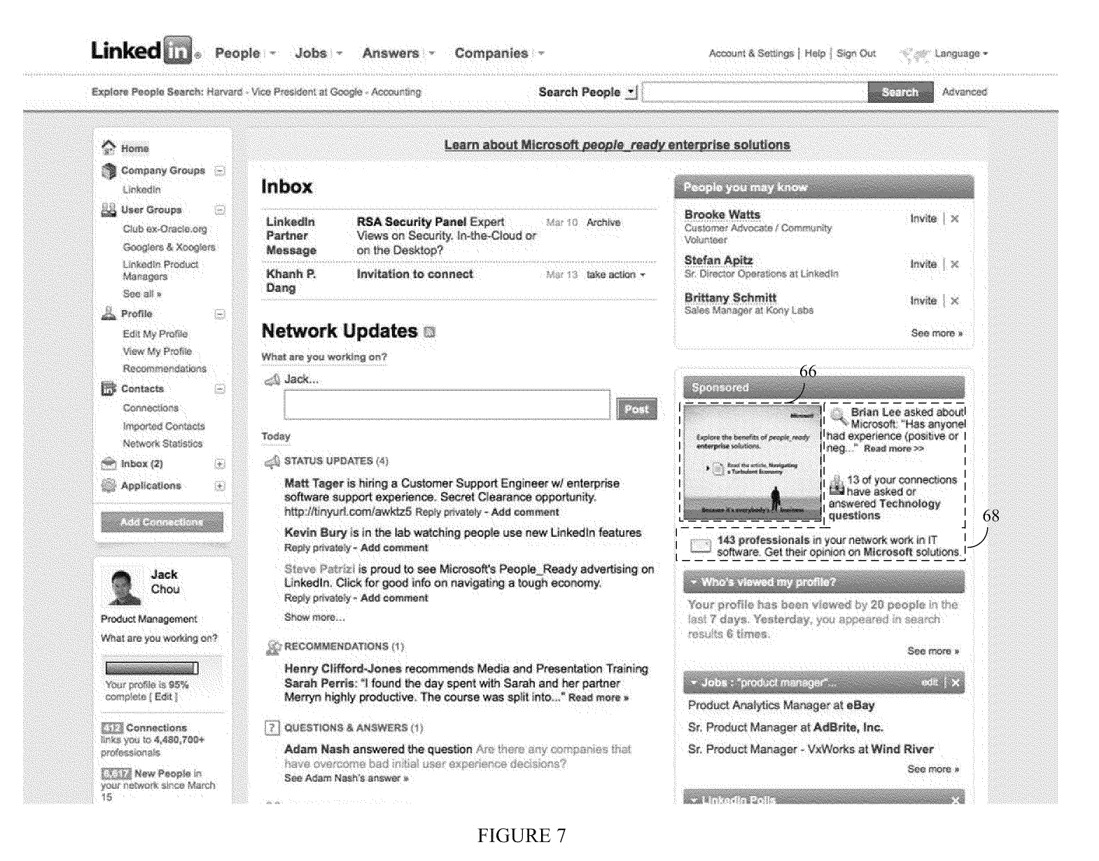

FIGS. 6 and 7 illustrate examples of various user interfaces showing display advertisements presented in conjunction with social/business network notifications, according to an embodiment of the invention. As illustrated in FIG. 6, the ad 62 is for the Wharton School of Business. In the box with reference number 64, several business network notifications are shown. For instance, one network notification indicates that “143 professionals in your network have MBA degrees.” Another network notification indicates that “11 members in your network are in the Wharton School Alumni group.” In FIG. 7, the ad 66 is for a company, specifically “Microsoft”. Accordingly, the business network notifications 68 are related in some way to Microsoft.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

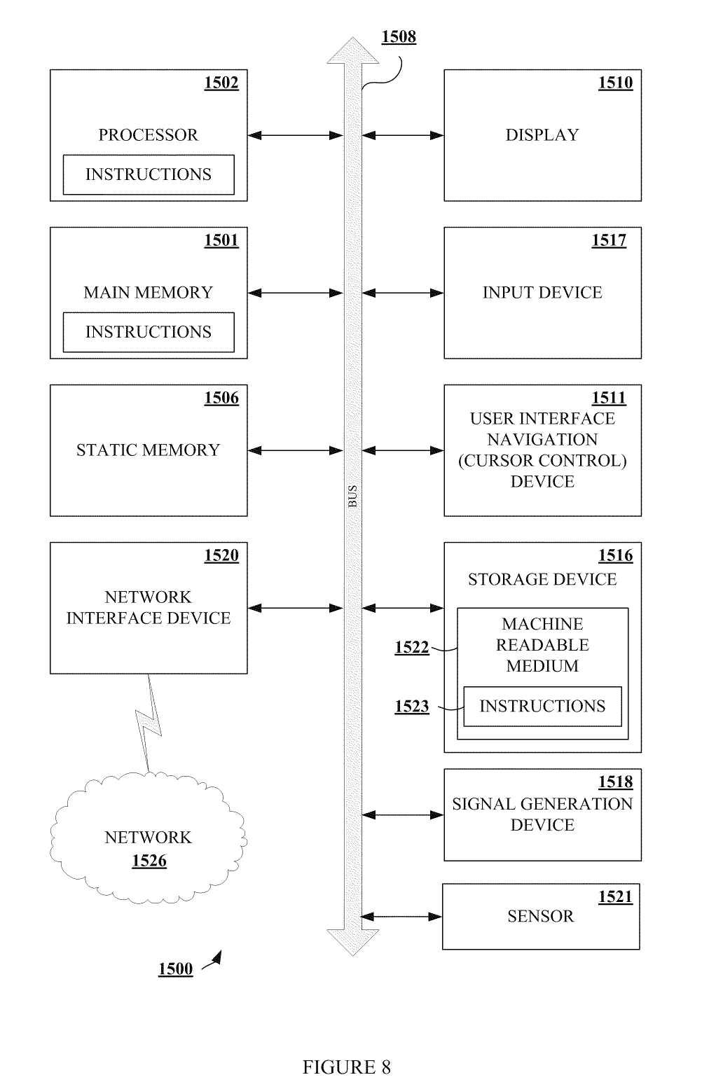

FIG. 8 is a block diagram of a machine in the form of a computer within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
automatically selecting an advertisement for display to a first user of a person-to-person networking service;
automatically selecting a network notification to be presented in conjunction with the selected advertisement, the network notification being selected based on the network notification including information associated with a second user of the person-to-person networking service who is related to the first user via the person-to-person networking service, and relating to content of the advertisement; and
causing the advertisement and the network notification to be presented to the first user by the person-to person networking service.

2. The computer-implemented method of claim 1, wherein the network notification pertains to a network interaction performed by the second user using the person-to-person networking service, the network interaction relating to the content of the advertisement.

3. The computer-implemented method of claim 2, wherein the first user is related to the second user by at least one of being directly connected to the second user or by belonging to a common group to which the second user belongs.

4. The computer-implemented method of claim 2, wherein the person-to-person networking service supports a plurality of user groups based on respective topics, and the network interaction is an interaction by the second user related to a group that is associated with the first user, and based on a first topic that is related to the subject matter of the advertisement.

5. The method of claim 2, wherein the person-to-person networking service supports topic forums, and the network interaction is an interaction related to a topic forum.

6. The computer-implemented method of claim 2, wherein automatically selecting a network notification to be presented in conjunction with the selected advertisement includes identifying a network notification that satisfies one or more ad campaign parameters specified by an advertiser.

7. The computer-implemented method of claim 6, wherein one ad campaign parameter identifies a topic to which a network notification is to relate in order for the network notification to be presented in conjunction with a particular display advertisement.

8. The computer-implemented method of claim 6, wherein one ad campaign parameter identifies an interaction type from which a network notification is to be selected.

9. A data processing apparatus comprising:
at least one processor; and
a machine-readable medium in communication with the at least one processor, the machine readable medium storing a networking service that is executable by the at least one processor, the networking service being executed by the at least one processor to cause operations to be performed, the operations comprising:
automatically selecting an advertisement for display to a first user of a person-to-person networking service;
automatically selecting a network notification to be presented in conjunction with the selected advertisement, the network notification being selected based on the network notification including information associated with a second user of the person-to-person networking service who is related to the first user via the person-to-person networking service, and relating to content of the advertisement; and
causing the advertisement and the network notification to be presented to the first user by the person-to person networking service.

10. The data processing system of claim 9, wherein the network notification pertains to a network interaction performed by the second user using the person-to-person networking service, the network interaction relating to the content of the advertisement.

11. The data processing system of claim 10, wherein the first user is related to the second user by at least one of being directly connected to the second user or by belonging to a common group to which the second user belongs.

12. The data processing system of claim 10, wherein the person-to-person networking service supports a plurality of user groups based on respective topics, and the network interaction is an interaction by the second user related to a group that is associated with the first user, and based on a first topic that is related to the subject matter of the advertisement.

13. The data processing system of claim 10, wherein the person-to-person networking service supports topic forums, and the network interaction is an interaction related to a topic forum.

14. The data processing system of claim 10, wherein automatically selecting a network notification to be presented in conjunction with the selected advertisement includes identifying a network notification that satisfies one or more ad campaign parameters specified by an advertiser.

15. The data processing system of claim 14, wherein one ad campaign parameter identifies a topic to which a network notification is to relate in order for the network notification to be presented in conjunction with a particular display advertisement.

16. The data processing system of claim 14, wherein one ad campaign parameter identifies an interaction type from which a network notification is to be selected.

17. A networking service comprising a notification module to automatically select a network notification to be presented in conjunction with a selected advertisement displayed in a web page, the network notification being selected based on the network notification including information that is i) associated with a user of the person-to-person networking service who is connected to the viewer of the selected advertisement via a person-to-person connection established with the networking service, and ii) relating to content of the advertisement.

18. The networking service of claim 17, wherein the network notification module is to automatically select the network notification to be presented in conjunction with the selected advertisement based on the network notification satisfying one or more ad campaign parameters specified by an advertiser to which the ad is related.

19. The networking service of claim 17, wherein the network notification module is to automatically select the network notification to be presented in conjunction with the selected advertisement by selecting the network notification based on the network notification having been assigned to a category that matches a category specified by an advertiser of the ad.
